(19) United States
(12) Patent Application Publication
(10) Pub. No.: US 2014/0215467 A1
(43) Pub. Date: Jul. 31, 2014

(54) Method and Virtualization Controller for Managing a Computer Resource With at Least Two Virtual Machines

(71) Applicants: Otto Niesser, Allersberg (DE); Halil Caglar Ünver, Nurnberg (DE)

(72) Inventors: Otto Niesser, Allersberg (DE); Halil Caglar Ünver, Nurnberg (DE)

(21) Appl. No.: 14/167,692

(22) Filed: Jan. 29, 2014

(30) Foreign Application Priority Data
Jan. 30, 2013 (EP) 13153288.9

(51) Int. Cl. G06F 9/455

(52) U.S. Cl. CPC G06F 9/45533
USPC 718/1

(57) ABSTRACT

A method and virtualization controller for use of a computer resource by a plurality of virtual machines, the virtualization controller being configured to virtualize the resource, wherein for sole access to the resource by a first of the virtual machines, direct access to the resource by the first virtual machine is provided, a virtual device is assigned to the second virtual machine for access to the resource, wherein, in the event of a request to access the resource from the second virtual machine, the direct access to the resource by the first virtual machine is terminated, control of the resource is completely assumed by the virtualization controller, a first virtual device is assigned to the first virtual machine for further access to the resource, and the second virtual machine accesses the resource using the second virtual device.

### BACKGROUND OF THE INVENTION

1. Field of the Invention

The invention relates to a method for managing a computer resource with at least two virtual machines and to a virtualization controller for implementing the method.

2. Description of the Related Art

In many applications, virtual runtime environments are implemented on computers, a plurality of virtual runtime environments (generally “virtual machines”) being able to be operated in a parallel manner on a hardware platform. Such virtualization makes it possible to operate a plurality of operating systems, even different operating systems, in a parallel manner.

In this case, virtualization provides the advantage that the individual virtual runtime environments are largely decoupled from one another. This means that it is not possible to interchange data between the runtime environments, apart from at interfaces provided for this purpose, and execution in one of the runtime environments, for example, therefore ideally does not have any negative effects on the execution of programs in other runtime environments.

Such an architecture is also used in industrial, smart-grid or other automation arrangements, where a control task is carried performed by one or more standard or real-time operating systems and automation programs running on the real-time operating systems. For example, an operating system with real-time capability (Real Time Operation System (RTOS)) can run on a computer and other operating systems, in particular “standard” or “all-purpose” systems such as Microsoft Windows 7 or Linux, which are also referred to as a General-Purpose Operation System (GPOS) here, run alongside in further virtual runtime environments. In another example, a plurality of GPOS operating systems can run on a computer on which different server applications are executed.

The aim of such a division of the available resources of a platform is the increased use of the same resources. The applications usually do not use the resources of the platform at full capacity. Another point is that different operating systems provide different functionalities and corresponding applications usually have not been developed in a very portable manner for a particular operating system. Instead of now allocating a separate hardware platform (computer) to each operating system and the applications running on the separate hardware platform, a computer can execute a plurality of operating systems and their applications via virtualization technologies.

The virtual runtime environments are generally produced and monitored by a management device, the management device assigning the resources of the hardware platform to the individual virtual runtime environments or, for some of the resources, accessing the resources in a manner representative of the virtual runtime environments. Such a management device is often referred to as a “hypervisor” or “virtual machine monitor” (VMM); the general designation “virtualization controller” is also intended to be used below. In this case, the hypervisor generally requires hardware support in the form of conventional virtualization technologies, such as VMX (Intel Virtualization Technology—VT-x) or SVM (AMD Secure Virtual Machine—SVM) which by now are usually provided by the common processors.

A virtualization controller, i.e., a hypervisor (VMM) (running as a standalone program directly on hardware, as part of firmware or of an operating system or as an application on an operating system), having a plurality of virtual machines (“VMs”) VM1, VMx and guest operating systems G1 . . . Gn (or “guests” for short) running on the latter shall be considered by way of example below, the hypervisor also being referred to as a “host” for its guest operating systems. A feature of this division is that the hypervisor runs in the root mode, whereas the VMs that accommodate its guests always run in the non-root mode. The hypervisor is implemented such that true (real, i.e., physically available) resources R of the underlying hardware can be allocated to the guest systems Gx.

Since the hypervisor is able to monitor I/O and memory access operations of its guests, to provide any desired data for these access operations and to transmit asynchronous events such as interrupts to the guests (for example “interrupt injection”), it is possible to emulate the functionality of any desired hardware, which is either not available on the system or, although available, is not intended to be allocated to the guests in a dedicated manner, with respect to the guests. If hardware is emulated in this manner, the hardware is consequently referred to as virtual hardware. In order to implement virtual hardware, one or more real devices may accordingly be available to the hypervisor; for example, a real hard disk memory, RAM memory or else a network drive may be used to emulate a virtual hard disk. Virtual hardware can be implemented in the hypervisor itself or in a further guest operating system specifically instrumented for this purpose and/or in its application.

The direct allocation of “true” (real) hardware, instead of virtual hardware, makes it possible to minimize the interaction of the hypervisor with its guests. As long as a resource is directly allocated, as a functionally independent unit of real hardware (for example. a device on the PCI bus or a function of a device on the PCI bus), to only one guest, the latter can access the resource without VMM control, i.e., the addresses of the resource are not monitored for the corresponding guest and access thereto does not result in interruptions in the execution of the guest. These addresses must be monitored for all other guests to prevent access to R to avoid inconsistency of the hardware state and other problems that may arise from uncontrolled alternate access. If a resource R is intended to be divided between a plurality of guests, it is still possible to dispense with the provision of virtual hardware as long as the hypervisor suitably coordinates the access to R in order to avoid overlaps in the access by different guests. This applies, in particular, to resources in which an individual job runs through different states that necessarily have to be executed in the predefined sequence.

Solution approaches for the problems described above within a virtualization controller are known from the prior art. For this purpose, access to the resource by the guests will be essentially monitored and/or prevented, true hardware access operations will be suitably coordinated and the access operations performed by the guests will be emulated to the guests according to a model of true hardware access operations.

Direct access to a resource by a guest is consequently also referred to as “non-virtualized” and access associated with VMM interaction is referred to as “virtualized”. For the latter, the I/O and/or memory-mapped areas belonging to the resource must be monitored by the hypervisor and access thereto must be interrupted. If a guest system has knowledge of the hypervisor environment and therefore accesses R by specifically initiated VMM interaction, this is referred to as “para-virtualized”. This designation is also retained when interaction takes place with a further guest system (service VM) which is specifically provided for the purpose of handling R and is logically considered to be part of the VMM although it itself does not run in the root mode but rather under the control of the VMM and communicates with the other guests using methods according to the prior art. If all access to a resource is possible only via VMM interaction, this is “fully virtualized” access in contrast to “partially virtualized” access that is a mixture of non-virtualized and virtualized access operations. The abovementioned interaction with the hypervisor, which is specifically initiated by the guest, is also referred to as a hypercall or hypervisor call.

However, there is the problem that access to a virtualized resource via the associated interactions with the VMM results in considerable performance disadvantages in comparison with direct access to the hardware of the resource. Although there are known methods that already make it possible to reduce these disadvantages, the results are not always satisfactory.

### SUMMARY OF THE INVENTION

It is therefore an object of the method and virtualization controller in accordance with the invention to further reduce the above-described performance disadvantages when distributing a hardware resource between a plurality of guests.

This and other objects and advantages are in accordance with the invention by a method and a virtualization controller in which a method for the use of a computer resource by at least two virtual machines is provided, where alternate access to the resource by the operating systems respectively installed on the virtual machines is performed, where a virtualization controller is configured to virtualize the resource, and where the resource is provided for each of the virtual machines in the virtualization controller as a first and a second virtual device. Here, for sole access to the resource by a first of the virtual machines, direct access to the resource by a first operating system of the first virtual machine is provided, where the second virtual device is assigned to the second virtual machine for access to the resource, and where, in the event of a request to access the resource from the second virtual machine, the direct access to the resource by the first virtual machine is terminated in a first step, and the control of the resource is completely assumed by the virtualization controller in a second step. With the connection of a transparent device, although the virtualization controller in principle already has full control of the resource, it does not use the latter but rather monitors only a usage cycle which is possibly still running. Only when a suitable time is identified will the virtualization controller also use control for full virtualization. The first virtual device is assigned to the first virtual machine in a third step for further access to the resource, and the second virtual machine accesses the resource in a fourth step using the second virtual device. This makes it possible for a plurality of virtual machines or the operating systems and processes running on the operating systems to alternately access resources, with either an individual machine being able to access the resources with high performance or a plurality of machines being able to respectively access the resources in a competing or virtually simultaneous manner, depending on requirements.

The object is also achieved by a virtualization controller for managing a computer resource with at least two virtual machines and for managing the access to the resource by the at least two virtual machines, where the virtualization controller is configured to provide a first virtual device for access to the resource by the first virtual machine and to provide a second virtual device for access to the resource by the second virtual machine. Here, for sole access to the resource by a first of the virtual machines, the virtualization controller is configured to configure direct access to the resource by the operating system of the first virtual machine, where the second virtual device is assigned to the second virtual machine having the second operating system for access to the resource, and, where, in the event of a request to access the resource from the second virtual machine having the second operating system, the direct access to the resource by the first virtual machine is terminated in a first step, the control of the resource is completely assumed by the virtualization controller in a second step, the first virtual device is assigned to the first virtual machine in a third step for further access to the resource, and the second virtual machine accesses the resource in a fourth step using the second virtual device. Such a virtualization controller Virtual Machine Monitor ((VMM) or hypervisor) can be used to achieve the advantages explained as part of the method.

It is possible to return to the high-performance method of operation, in which one of the virtual machines directly and exclusively uses the resource, by virtue of the fact that, after the fourth step has been concluded, the direct access to the resource by the first virtual machine is restored in a fifth step.

The method can be used in a particularly advantageous manner if a hardware resource is used as the resource because hardware resources cannot be duplicated any desired number of times, whereas software resources (e.g., services) can be duplicated in a simpler manner as long as computer hardware has sufficient basic resources (memory and processor power). The hardware resource may be advantageously a mass memory or another device that cannot be used by a plurality of entities in a competing manner.

During the control of the resource by the virtualization controller, the access to the resource by the first virtual machine using the first virtual device is advantageously performed alternately with the access by the second virtual machine using the second virtual device, with the result that both virtual machines or the operating systems supported by the operating systems can each use the resource.

The virtualization controller advantageously monitors the operating state of the resource, where the first step is performed only when the resource has an operating state suitable for this purpose. This makes it possible for ongoing use of the resource to be concluded properly before the method of operation is changed. Analogously thereto, a suitable operating state can likewise be awaited before returning to the original method of operation. Idling of the resource or conclusion of a processing cycle is advantageously awaited as a suitable operating state.

If, before the first step is performed, access to the second virtual device by the second virtual machine is buffered by the virtualization controller, where the first step and the subsequent steps are performed only after a defined number of buffered access operations has been reached and/or after a preset waiting time has elapsed, the number of changes of the method of operation can be reduced, whereby the delays occurring in the event of a change can be minimized.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the method according to the invention are explained below using the drawings; exemplary embodiments of virtualization controllers according to the invention are therefore simultaneously explained, in which:

FIG. 1 shows states of job processing of an exemplary resource;

FIG. 2 shows a first operating state in which an operating system exclusively uses the resource via direct access;

FIG. 3 shows a second operating state with competing access to the resource by two operating systems in accordance with the invention;

FIG. 4 shows a transition from the first operating state to the second operating state in accordance with the invention;

FIG. 5 shows an overview of the transitions between the individual operating states in accordance with the invention; and

FIG. 6 is a flowchart of the method in accordance with the invention.

### DETAILED DESCRIPTION OF THE PREFERRED EMBODIMENTS

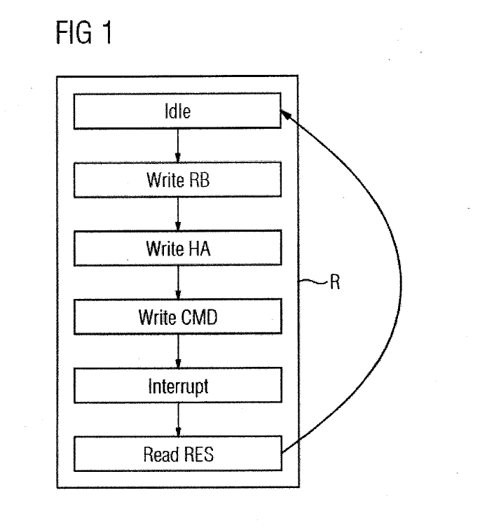

The method described below is explained using a resource R which is illustrated in a simplified manner in FIG. 1 and the states of which are illustrated in a sequence diagram. The starting point in this case is “idling” (idle) in which a processing cycle can be started. After a last state (Read_RES) (reading a result from a register or the like), the state jumps back to the idle state, which is visualized in all figures via a corresponding upward arrow. It remains to be noted that the state model of a true resource R can deviate from the simplified example illustrated, but this cannot affect the described method in accordance with the invention.

The resource R is parameterized by writing the block number of a resource block RB and a physical host address HA for the useful data memory to the registers RB and HA provided for this purpose. The sequence of this parameterization can be predefined both freely and firmly in different examples, which is mentioned here only when it matters. After the resource R has been parameterized, the read or write job CMD is performed via a “read” or “write” command to the command register CMD and is then acknowledged via an interrupt. Finally, the result of the job can be checked by reading the result register RES. The registers of the resource R can be read and written to on real systems via memory mapped I/O or via I/O access. Other hardware components may also influence the function of the resource R and must therefore also be handled in a real system, such as the interrupt controller.

Error branches in the resource states are not discussed here because they do not change anything in the basic principles. It is only assumed that an absent interrupt after a defined time indicates the failure of the job, which is then also manifested in RES.

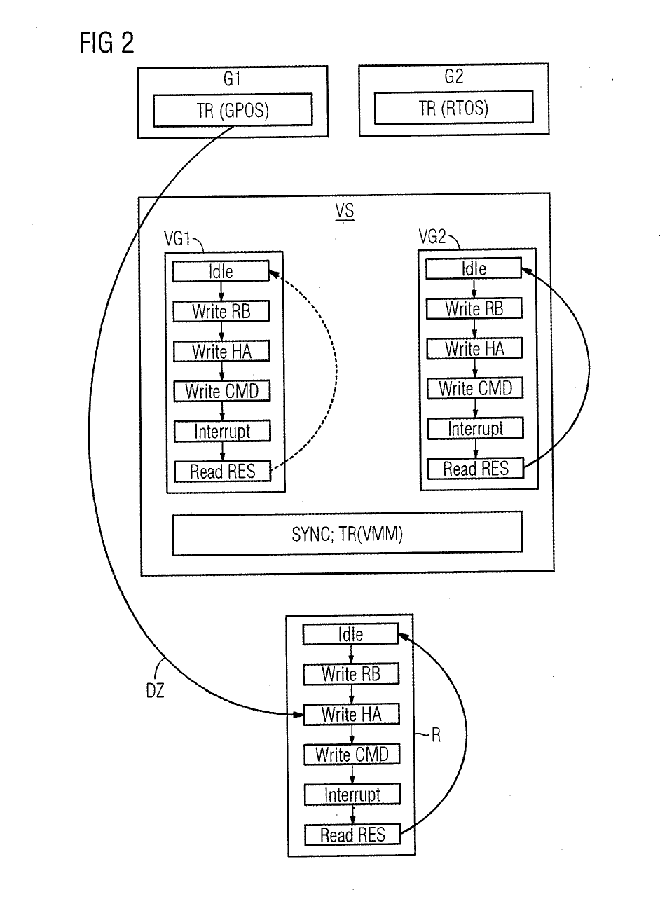

FIG. 2 illustrates the situation in which the guest G1 exclusively accesses the resource R. Here, no virtual device VG1 is interposed for G1, but rather direct access DZ is performed. For the guest G2, the virtual device VG2 prevents direct access to the resource R and, in the event of an access attempt, will cause the virtualization controller VS to assume the control of the resource R. The virtual device VG2 must necessarily be activated for the period in which the guest G1 has direct access to the resource R.

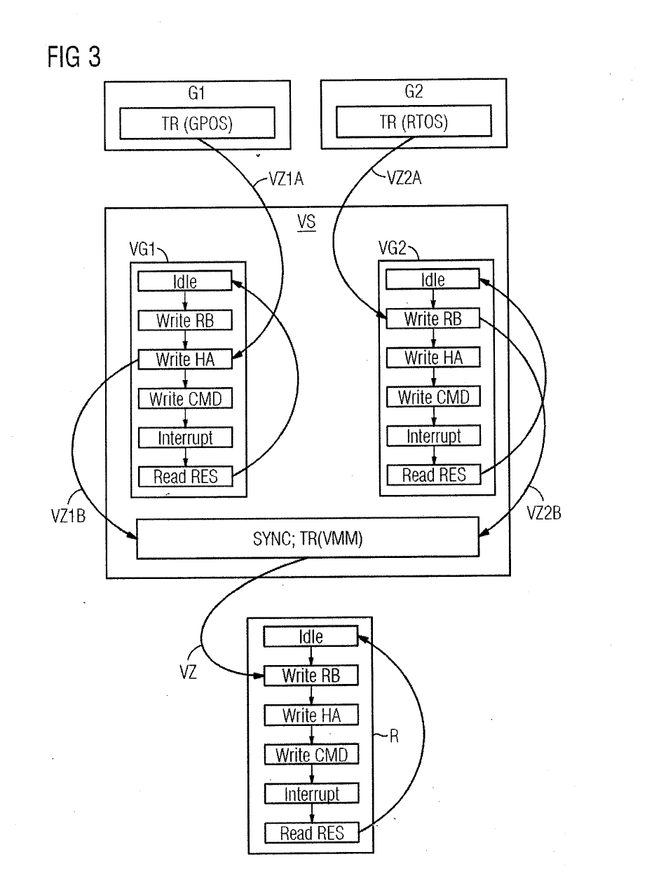

The situation of competing access is illustrated in FIG. 3 and shows the synchronization of two virtual machines (guests G1, G2) in the event of joint access to the resource R. This FIG. 3 corresponds to the prior art for competing access operations.

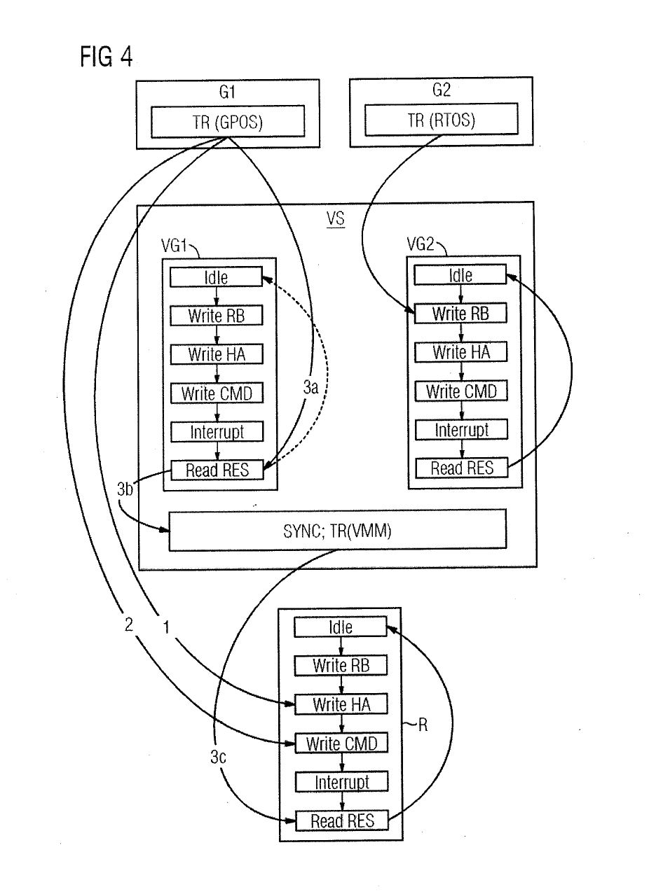

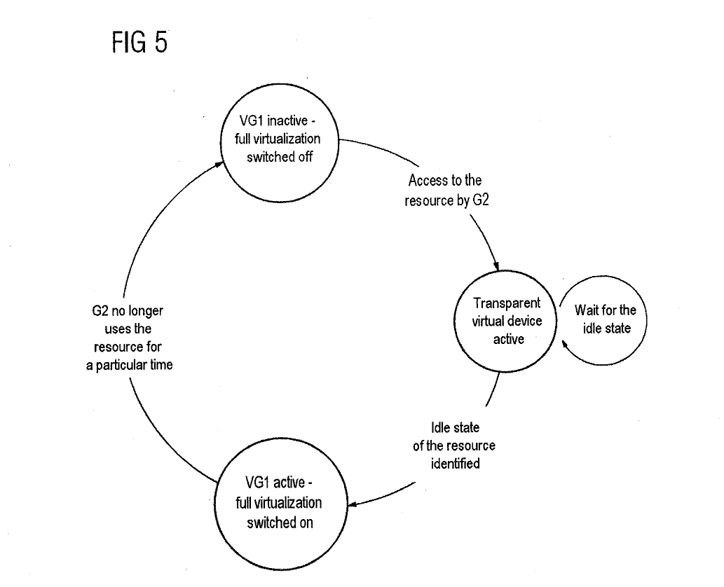

FIG. 4 finally illustrates the interposition of a virtual device VG1 after an access attempt by the guest G2. The virtual device VG1 is transparent in this operating state. As a result, the virtual device VG1 it is referred to as a transparent virtual device in the context of FIGS. 4 and 5.

Details and different strategies within the scope of the method are discussed in the following sections.

A virtual device can be implemented in different ways in the prior art. On the one hand, the full virtualization of the device is possible. In this case, the hypervisor can identify complete jobs and can then execute these jobs under its own control. With this method, different guests can access their virtual devices for R in a parallel manner, and the hypervisor can manage the identified jobs at its own discretion. On the other hand, partial virtualization can also be used. Here, only individual registers of the resource R are monitored and access is enabled for that guest which is currently processing an access sequence. In this case, the hypervisor (virtualization controller (VS)) can manage only the right of the guests to access the resource R. On account of the larger number of monitored registers, memory or I/O areas, full virtualization has performance disadvantages in comparison with the partially virtualized solution but is more flexible and does not cause any problems when identifying and monitoring the access sequences.

For operating systems that are aware of their execution in a virtual machine, it is possible to install a driver that advantageously moves the access to the resource R to the hypervisor or a separate virtual machine (“service VM”), via para-virtualization, with the result that the access to the hardware by the guest operating system therefore no longer needs to be monitored and associated performance disadvantages are avoided. However, this is not stated any further here.

The exclusive use of the resource R by a first virtualized operating system GPOS installed on a first virtual machine G1 (guest) shall be explained below as a starting point of the method using FIG. 2. For this purpose, a system (hardware platform, such as a personal computer) having a virtualization controller VS (Virtual Machine Manager (VMM)) and two “guests”, the virtual machines G1 and G2, is provided by way of example. G1 is a general operating system GPOS (General-Purpose Operating System), such as Microsoft Windows 7, for visualization and data storage and G2 is a real-time operating system RTOS (Real Time Operating System) with time-critical control and management jobs, such as signal processing and/or real-time communication. However, G2 may alternatively also be a second general operating system. Each of the guest operating systems has specific drivers TR(GPOS), TR(RTOS) for operating the resource R.

The resource R to be jointly used is, for example, a hard disk that serves G1 as a system and data disk that is used at high frequency. G2 uses the disk to occasionally store the process data and to occasionally load recipe data or other data, which are usually permanently in the main memory, and therefore rarely accesses the hard disk.

As seen from this example, the occasional use of the resource R by G2 in the prior art also gives rise to the need for virtualized access by G1, the performance of which is impaired thereby. The present method shows ways of optimizing the performance for that guest G1 which is the main user of the resource R in a virtualization controller VS with highly asymmetrical use of a joint resource R by a plurality of guests G1, G2.

As illustrated in FIGS. 2 to 5, the virtualization controller VS establishes virtual devices VG1, VG2 for the resource R. In this case, a virtual device VG1, VG2 is generally understood as meaning a virtualizing intermediate layer as part of the virtualization controller VG, which intercepts, synchronizes and possibly suitably modifies the hardware access to the resource R by the guest systems G1, G2 and finally forwards it to the resource R. Here, use is made of virtualization technologies that are provided by the processor, can monitor I/O and memory areas and transfer the control from the guest to the virtualization controller VS in the event of appropriate access. Interrupt sources on the interrupt controller are likewise parameterized such that the interrupt of R is intercepted by the virtualization controller VS and is forwarded to the correct guest G1, G2.

As a special case, a “transparent” virtual device forwards the intercepted access operations to registers of the resource R and/or reactions of the resource R, such as interrupts, without change and can also read registers of the resource R in an arbitrary manner to detect the state of the resource R as long as this does not impair the function of the resource R. For this purpose, the virtual device VG1 is in the form of a transparent virtual device in FIG. 4. It is used only to provide the virtualization controller VS with information relating to the ongoing access operations. This can be used, for example, to identify a suitable point for interrupting the access by the guest G1 or else for collecting statistical data relating to the access frequency. A guest G1 using a resource R controlled by a transparent virtual device behaves like a “non-virtualized” guest and therefore has exclusive access to the resource R but with slightly reduced performance on account of interaction with a virtualization controller VS.

In the text below, G1 is that guest which uses the jointly required resource R at high frequency, and G2 uses the resource R only sporadically. The fundamental state of the described method, as illustrated in FIG. 1, is now that of enabling non-virtualized access (direct access DZ) to R for G1 in the normal situation. G1 can therefore use the resource R in the normal situation without performance disadvantages. In this operating mode, direct access to the resource R is not possible at all for G2. As mentioned, each guest G1, G2 has its own drivers TR(GPOS), TR(RTOS) for accessing the resource R, but the driver TR(RTOS) is not used in this operating state and cannot be used for direct access DZ to the resource R. Only in the event of an attempt by the guest G2 to use the resource R is the driver TR(RTOS) used for the first time. As soon as the hypervisor of G2 registers a desire to access R, the non-virtualized access by G1 is converted to virtualized access by interposing a virtual device.

This state is illustrated in FIG. 3. Here, both guests G1, G2 now access the resource G with equal rights by accessing VZ1A, VZ2A the interposed virtual devices VG1, VG2, the virtualization controller VS synchronizing the access operations VZ1B, VZ2B generated by the virtual devices VG1, VG2 by means of an intermediate layer SYNC; TR(VMM) (synchronization and driver for the resource R in the virtualization controller); a sequence of access operations VZ results. In this case, the intermediate layer SYNC; TR(VMM) can process the access operations VZ1B, VZ2B alternately, for example, or can channel them according to other strategies, for example, according to a priority or time-slicing method.

The transition from the state of exclusive use (direct access DZ) according to FIG. 2 to competing access according to FIG. 3 is explained below using FIG. 4. The sequence and interaction of the states is illustrated in FIG. 5.

As already mentioned above, the virtual device VG1 is initially a “transparent” virtual device. The hypervisor (virtualization controller (VS)) is therefore initially not yet able to fully control the resource R since it is not known whether the resource R is currently being used. Access operations by the guest G1 occur directly, see arrows 1 and 2 in FIG. 4. By means of the interposed transparent virtual device, the virtualization controller VS can now monitor the still direct, non-virtualized access to R by G1 and can determine the part of the access sequence (see FIG. 1) in which the access to the resource R by the guest G1 is currently situated. In this case, at least the idle state of the resource R must be able to be clearly identified here, which can be performed here by monitoring the access to the register RES (result) (arrows 3a, 3b, 3c) or else by monitoring the interrupt, for example.

Two situations can be distinguished in this case. On the one hand, it is possible that the guest G1 is currently not performing any access operations. The resource R is therefore already in the desired state (idle). It is now necessary to distinguish whether the virtualization controller VS is able to reliably identify this idle state based on the conditions of R. If this is the case, the desired state has already been reached. If not, the virtualization controller VS must await at least the timeout predefined by the resource R before the virtualization controller VS can be sure that no job is currently being processed.

In contrast, in the second situation, the access sequence which has been run through can be identified independently of the general identifiability of the idle state using the access to registers of the resource R. The virtualization controller VS can therefore determine the time at which the resource R is in the idle state.

As soon as the virtualization controller VS has identified the idle state of the resource R, a virtual device VG1 is interposed for fully virtualized access to the resource R for the guest G1 (see FIG. 3). From this point on, the resource R is divided between G1 and G2 using conventional methods (e.g., fully virtualized operation). It should be noted that the virtual devices VG1, VG2 used for this purpose can also use mechanisms that extend beyond the simple monitoring of I/O and memory addresses and interrupts.

After the guest G2 has performed its access operations (see access VZ2B in FIG. 3), the virtual device VG1 can be switched off at a point at which the resource R is in the idle state and the non-virtualized, direct access DZ (see FIG. 2) or the monitored, non-virtualized access to the resource R, as described within the scope of FIG. 4, can be re-enabled for the guest G1.

An increase in performance in the transparent virtual device VG1 (FIG. 4) is possible if the idle state of the resource R can be determined without completely monitoring the access sequence. The scope of the registers of the resource R that are monitored by the virtualization controller VS can then be minimized by only monitoring what is needed to identify the idle state. In the present example, it is possible to be restricted to monitoring the interrupt and the subsequent reading of the status in the register RES, for example.

A further increase in performance can be effected via job buffering. For this purpose, the virtualization controller VS can buffer the only occasional access operations VZ2A by the guest G2 and can only subsequently independently process them further. Different strategies are possible in this case, in particular the collection of a plurality of jobs that are executed on the resource R using the described method only after a particular number has been reached or after a particular time has elapsed. This procedure is advantageous, in particular, when it is not possible or there is no desire to interrupt G1 during a time-critical transaction and, at the same time, G2 is not supposed to wait for the completion of its job. G1 can mark such a transaction on the resource R via “locking mechanisms”, which can be implemented, for example, via a command sent to the virtualization controller VS, such as a hypercall/hypervisor call/VM-EXIT.

The above-described “timeout mechanism” for determining the idle state can be avoided in an advantageous embodiment. As described, in the situation in which the idle state of the resource R cannot be determined without completely monitoring the access sequence, the guest G1 can await a “timeout” to reliably exclude the processing of a job. This timeout can be avoided because, in the absence of activity on the resource R by G1, the guest G1 transmits dummy jobs to R that are not required for the execution of G1 but allow the hypervisor (virtualization controller VS) to identify an idle state of the resource R more quickly than would be possible using the timeout mechanism. These jobs should ideally be read jobs and should be transmitted at a higher frequency than the timeout value. At the same time, they should have a low priority in G1 to avoid unnecessarily hindering the execution of G1. The dummy jobs described here can be implemented in G1 both as drivers and as an application.

The practice of using virtual devices VG1, VG2 makes it possible for the virtualization controller VS, in addition to coordinating the access operations themselves, to compile statistics relating to the use of a resource R by the individual guests G1, G2. In the case of non-competing access to R (see FIG. 2), a transparent virtual device can also be used for this purpose (see explanation relating to FIG. 4). These statistical data can be used to advantageously assign guest systems to an access frequency. The roles of the guest frequently accessing the resource R and of the guests sporadically accessing the resource R can therefore be dynamically changed in the presented method, which improves the method with temporarily increased access rates in a guest. In the case of a dynamically increased access frequency of a plurality of guests, the method can be advantageously suspended in all guests in favor of the use of virtual devices.

The cyclical evaluation of data collected over a relatively long period of time by a guest, which occurs daily at a particular time, is mentioned here as an example. The hypervisor can use its access statistics to foresee that the corresponding guest will have an increased access frequency to the resource R at this time and can preferably allocate the resource R to the guest in a corresponding manner.

In contrast to the above-described approach of having the virtualization controller VS itself identifying or predicting an increased access frequency by evaluating statistical access data, a guest can also itself inform the virtualization controller VS of its access frequency to the resource R using a communication method, such as a hypercall. In this manner, the guest G2, for example, will inform the virtualization controller VS, before accessing its data repository, of the now following large quantities of access operations so that the virtualization controller can adjust the strategy thereto, i.e., the virtualization controller can either treat G1 and G2 as guests with a similar access frequency to R or can now even provide G1, as a guest, with a low access frequency and can therefore provide G2, as a machine, with preferably direct access to the resource R. After the access to the data repository has been concluded, the virtualization controller VS is again informed of the access frequency which is now reduced again, such as a hypercall. This method can be combined with the above-described statistical method by assessing the announcement of a particular access frequency with the values obtained from the statistics and making corresponding adaptations to the virtualization strategy of R.

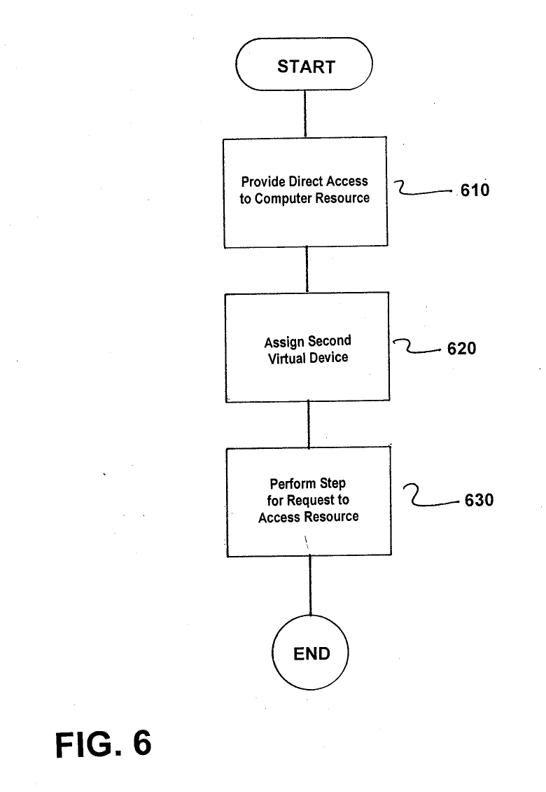

FIG. 6 is a flowchart of a method for use of a computer resource (R) by a plurality of virtual machines (G1, G2), where alternate access is provided to the resource (R) by the operating systems respectively installed on the virtual machines (G1, G2), a virtualization controller (VS) is configured to virtualize the computer resource (R), and the computer resource (R) is provided for each of the plurality of virtual machines (G1, G2) in the virtualization controller (VS) as a first and a second virtual device (VG1, VG2). The method comprises providing direct access (DZ) to the computer resource (R) by a first operating system of the first virtual machine (G1) of the plurality of virtual machines (G1, G2) for sole access to the computer resource (R) by the first of the virtual machine (G1), as indicated in step 610. The second virtual device (VG2) is then assigned to a second virtual machine (G2) of the plurality of virtual machines (G1, G2) for access to the computer resource (R), as indicated in step 620.

In the event of a request to access the resource (R) from the second virtual machine (G2), the direct access (DZ) to the computer resource (R) by the first virtual machine (G1) is terminated, control of the computer resource (R) is completely assumed by the virtualization controller (VS), the first virtual device (VG1) is assigned to the first virtual machine (G1) for further access to the computer resource (R), and the second virtual machine (G2) accesses the computer resource (R) using the second virtual device (VG2), as indicated in step 630.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for use of a computer resource by a plurality of virtual machines, alternate access being provided to the resource by the operating systems respectively installed on the virtual machines, a virtualization controller being configured to virtualize the computer resource, and the computer resource being provided for each of the plurality of virtual machines in the virtualization controller as a first and a second virtual device, the method comprising:
providing direct access to the computer resource by a first operating system of the first virtual machine of the plurality of virtual machines for sole access to the computer resource by the first of the virtual machine; and
assigning the second virtual device to a second virtual machine of the plurality of virtual machines for access to the computer resource; and
wherein, in an event of a request to access the resource from the second virtual machine:
the direct access to the computer resource by the first virtual machine is terminated;
control of the computer resource is completely assumed by the virtualization controller;
the first virtual device is assigned to the first virtual machine for further access to the computer resource; and
the second virtual machine accesses the computer resource using the second virtual device.

2. The method as claimed in claim 1, wherein, after the first virtual device is assigned to the first virtual machine for further access to the resource, the direct access to the computer resource by the first virtual machine is restored.

3. The method as claimed in claim 1, wherein the computer resource comprises a hardware resource.

4. The method as claimed in claim 3, wherein the hardware resource comprises one of (i) a mass memory and (ii) another device which is temporarily utilizable only by one entity.

5. The method as claimed in claim 1, wherein during the control of the computer resource by the virtualization controller, the access to the computer resource by the first virtual machine utilizing the first virtual device is performed alternately with the access by the second virtual machine using the second virtual device.

6. The method as claimed in claim 1, wherein the virtualization controller monitors an operating state of the computer resource; wherein termination of the direct access to the resource by the first virtual machine is performed only when the computer resource has an operating state suitable for the termination.

7. The method as claimed in claim 6, wherein one of (i) idling of the computer resource and (ii) conclusion of a cycle of a processing cycle is awaited as a suitable operating state.

8. The method as claimed in claim 1, wherein before the direct access to the computer resource by the first virtual machine is terminated, access to the second virtual device by the second virtual machine is buffered by the virtualization controller; and wherein the direct access to the computer resource by the first virtual machine is terminated and subsequent steps are performed only at least one of (i) after a defined number of buffered access operations has been reached and (ii) after a preset waiting time has elapsed.

9. A virtualization controller for managing a computer resource with a plurality of virtual machines and for managing access to the computer resource by the plurality of virtual machines, the virtualization controller being configured to provide a first virtual device for access to the computer resource by a first virtual machine of the plurality of virtual machines and to provide a second virtual device for access to the computer resource by a second virtual machine of the plurality of virtual machines;
wherein, for sole access to the computer resource by a first of the virtual machines, the virtualization controller configures direct access to the computer resource by the operating system of the first virtual machine, the second virtual device being assigned to the second virtual machine having the second operating system for access to the computer resource, and
wherein, in an event of a request to access the computer resource from the second virtual machine having the second operating system:
the direct access to the computer resource by the first virtual machine is terminated;
control of the computer resource is completely assumed by the virtualization controller;
the first virtual device is assigned to the first virtual machine for further access to the computer resource; and
the second virtual machine accesses the computer resource utilizing the second virtual device.

10. The virtualization controller as claimed in claim 9, wherein after the first virtual device is assigned to the first virtual machine for further access to the computer resource, the virtualization controller is configured to restore the direct access to the computer resource by the first virtual machine.

11. The virtualization controller as claimed in claim 9, wherein the virtualization controller is configured to utilize a hardware resource as the computer resource.

12. The virtualization controller as claimed in claim 10, wherein the virtualization controller is configured to utilize a hardware resource as the computer resource.

13. The virtualization controller as claimed in claim 11, wherein the virtualization controller is configured to utilize one of (i) a mass memory and (ii) another device temporarily utilizable only by one entity as the hardware resource.

14. The virtualization controller as claimed in claim 9, wherein during control of the computer resource by the virtualization controller, access to the resource by the first virtual machine utilizing the first virtual device is performed alternately with access by the second virtual machine utilizing the second virtual device.

15. The virtualization controller as claimed in claim 9, wherein the virtualization controller monitors the operating state of the computer resource; and wherein the termination of the direct access to the resource by the first virtual machine is performed only when the computer resource has an operating state suitable for the termination.

16. The virtualization controller as claimed in patent claim 15, wherein one of (i) idling of the computer resource and (ii) conclusion of a cycle of a processing cycle is awaited as a suitable operating state.

17. The virtualization controller as claimed in claim 9, wherein before the termination of the direct access to the computer resource by the first virtual machine, access to the second virtual device by the second virtual machine is buffered by the virtualization controller, and wherein the termination of the direct access to the computer resource by the first virtual machine and subsequent steps are performed only one of (i) after a defined number of buffered access operations has been reached and (ii) after a preset waiting time has elapsed.
